(19) United States
(12) Patent Application Publication
(10) Pub. No.: US 2003/0084300 A1
(43) Pub. Date: May 1, 2003

(54) System for administrating data including privacy of user in communication made between server and user's terminal device

(75) Inventor: Yuichi Koike, Tokyo (JP)

Correspondence Address: McGinn & Gibb, PLLC, Suite 200, 8321 Old Courthouse Road, Vienna, VA, 22182, US

(73) Assignee: NEC Corporation, Tokyo (JP)

(21) Appl. No.: 10/274,945

(22) Filed: Oct. 22, 2002

(30) Foreign Application Priority Data
Oct. 23, 2001 (JP) 2001-324976

(51) Int. Cl. H04L 9/00

(52) U.S. Cl. 713/182

(57) ABSTRACT

A system for administrating data including privacy of a user in communication made between a server and a terminal device of the user, includes (a) a server, (b) a terminal device owned by the user, and (c) a privacy data administrator connected between the server and the terminal device which privacy data administrator compares a privacy policy made by the server and a privacy preference determined by the user to each other, and determines whether it is allowed to provide data including privacy of the user to the server.

### BACKGROUND OF THE INVENTION

1. Field of the Invention

The invention relates to a system for administrating data including privacy of a user in communication made between a server and a terminal device of the user.

2. Description of the Related Art

In these days, services which require a user to provide data including privacy of the user are increased in Internet. In Internet, since data including privacy of a user can be readily copied or peeped, technology for protecting such data is quite important.

One of important factors for protection of data including privacy of a user is agreement between a service provider and a user. For instance, there were cases wherein after a user provided data indicative of his/her address to a service provider for mailing goods to him/her, he/she received a lot of junk mails against his/her grain. Such cases are frequently caused by incomplete agreement between a user and a service provider at a stage when the user provides data about his/her privacy to the service provider.

In current services in Internet, a privacy policy is disclosed for assisting agreement between a user and a service provider. A privacy policy includes a kind of data including privacy of a user, to be collected, a purpose of collecting data including privacy of a user, and so on, and is disclosed by a service provider. Only when a user accepts a privacy policy, data about his/her privacy is provided to a service provider.

However, a privacy policy has much volume to read. Accordingly, a privacy policy is rarely read by a user, and hence, the privacy policy system has not worked well. For instance, according to statistics having been conducted by a certain on-line shopping site, a rate of users who read a privacy policy before inputting data about his/her privacy for shopping was smaller than 0.1%.

In order to such a problem as mentioned above, there has been suggested a platform for privacy preference (usually abbreviated as “P3P”).

In P3P, a service provider describes a privacy policy in a language readable by a computer, called as XML (eXtensible Markup Language), and puts the XML-type privacy policy in a server. On the other hand, a user in advance installs a preference used to distinguish acceptable privacy policies and unacceptable privacy policies from each other, in a client program (such as a web browser) of his/her terminal device. When a user makes access to a service provider, his/her browser automatically receives a XML-type privacy policy from the service provider, and judges whether the received XML-type privacy policy is acceptable to the user, based on the preference installed in a client program of his/her terminal device.

The above-mentioned P3P system makes it possible for a user's terminal device to output a warning to a user only when he/she is going to receive a service which may not protect his/her privacy data. As a result, a user can protect data about his/her privacy in accordance with the privacy preference without reading a privacy policy.

However, the above-mentioned conventional system is accompanied with problems, as follows.

The first problem is as follows. A terminal device has to have high performance ability to judge whether a privacy policy presented by a service provider is consistent with a privacy preference established in advance by a user, that is, a standard used to determine whether a privacy policy of a service provider is acceptable or not. Accordingly, a terminal device having low performance ability cannot make such a judgment as mentioned above.

In order to judge whether a privacy policy presented by a service provider is consistent with a privacy preference established in advance by a user, a terminal device has to receive a privacy policy of a service provider from a server of the service provider, and compare the received privacy policy to a privacy preference established by a user. Hence, it is absolutely necessary for a terminal device of a user to have high performance ability. Since a conventional terminal device widely used for making communication through Internet, such as a cellular phone, has just low performance ability, it was quite difficult or almost impossible for a conventional terminal device to make such Judgment as mentioned above.

The second problem is as follows. In order to follow agreement made between a service provider and a user, a terminal device has to have a function of filtering data to prevent data including privacy of a user which data is not covered by the agreement, from being transmitted to a server of a service provider to a terminal device of a user. A terminal device has to have high performance ability to accomplish such a data-filtering function. Accordingly, it was quite difficult or almost impossible for a conventional terminal device having just low performance ability, to accomplish such a data-filtering function.

For instance, as one of steps to be carried out in the above-mentioned P3P, a service provider requests a user-to provide a temporary identifier (ID) to the service provider in order to identify a terminal device of the user. If a user accepts such a request, the user transmits a temporary identifier to a service provider, and has to store the temporary identifier in a memory of his/her terminal device until the temporary identifier becomes unnecessary to the service provider. This step requires high performance ability to a terminal device. Accordingly, a conventional terminal device such as a cellular phone cannot carry out such a step.

Japanese Unexamined Patent Publication No. 2001-67323 (A) has suggested a method of administrating data including privacy of a user. This method includes the steps of storing a plurality of pairs of data including privacy of a user and a privacy policy into a database, retrieving the pairs meeting with a privacy policy and the privacy preference among all of the pairs, dynamically making data including privacy, having been already disclosed, and data about licensing, based on the retrieved pair and the privacy preference, and providing the thus made data to a service provider.

Japanese Unexamined Patent Publication No. 2001-78273 (A), based on the U.S. patent applications serial Nos. 145439 filed on Jul. 23, 1999 and 559230 filed on Apr. 26, 2000, has suggested a method of administrating data including privacy, relating to a client apparatus, including the steps of receiving a request from the client apparatus, determining whether agreement is necessary for making a response to the request, making agreement for providing data including privacy, when it is determined that agreement is necessary for making a response to the request, and transmitting a response.

However, the above-mentioned problems remain unsolved even in the above-mentioned Publications.

### SUMMARY OF THE INVENTION

In view of the above-mentioned problems in the conventional systems, it is an object of the present invention to provide a system for administrating data including privacy of a user in communication made between a server and a terminal device of a user, in which decision as to whether data including privacy of a user is to be provided to a service provider is automatically made, based on both a privacy policy of the service provider and a privacy preference of the user, even in a terminal device of the user such as a cellular phone.

It is also an object of the present invention to provide a system for administrating data including privacy of a user in communication made between a server and a terminal device of a user, which system accomplishes a function of filtering data, based on both a privacy policy of the service provider and a privacy preference of the user, even in a terminal device of the user such as a cellular phone.

In one aspect of the present invention, there is provided a system for administrating data including privacy of a user in communication made between a server and a terminal device of the user, including (a) a server, (b) a terminal device owned by the user, and (c) a privacy data administrator connected between the server and the terminal device which privacy data administrator compares a privacy policy made by the server and a privacy preference determined by the user to each other, and determines whether it is allowed to provide data including privacy of the user to the server.

For instance, the privacy data administrator allows the data including privacy of the user to be provided to the server from the terminal device therethrough, when the privacy data administrator determines that it is allowed to provide the data to the server.

For instance, the privacy data administrator allows a request transmitted from the server for providing the data including privacy of the user to the server, to be transmitted to the terminal device therethrough, when the privacy data administrator determines that it is allowed to provide the data to the server.

For instance, the privacy data administrator, when the privacy data administrator determines that it is not allowed to provide the data including privacy of the user to the server, transmits a first inquiry to the terminal device as to whether it is allowed to provide the data including privacy of the user to the server, and receives a reply from the terminal device.

The privacy data administrator may (a) store the reply made in response to each of various inquiries, (b) when the privacy data administrator has determined that it was not allowed to provide the data including privacy of the user to the server, check whether a reply having been made in response to an inquiry identical with the first inquiry is stored therein, (c) if the reply is stored therein, does not transmit the inquiry identical with the first inquiry to the terminal device, and (d) treat the reply stored therein as a reply to be made in response to the inquiry.

The privacy data administrator may revise the data including privacy of the user in accordance with the privacy preference, based on comparison of the privacy preference to the privacy policy, and provides the thus revised data to the server.

The privacy data administrator may revise the data including privacy of the user in accordance with the privacy preference, based on both comparison of the privacy preference to the privacy policy and the reply having been made from the terminal device in response to the inquiry, and provides the thus revised data to the server.

The data including privacy of the user may include at least one of (a) data which identifies the user, (b) an address of the user, (c) an age of the user, (d) a telephone number of the user, (e) data which identifies the terminal device of the user, (f) data indicative of environment of the terminal device, (g) data indicative of network environment of the terminal device, and (h) data indicative of programs installed in the terminal device.

The privacy data administrator may include a device which can identify a location of the terminal device, and wherein the data including privacy of the user includes at least one of (a) data which identifies the user, (b) an address of the user, (c) an age of the user, (d) a telephone number of the user, (e) data which identifies the terminal device of the user, (f) data indicative of environment of the terminal device, (g) data indicative of network environment of the terminal device, (h) data indicative of programs installed in the terminal device, and (i) data indicative of a location of the terminal device.

The server may provide at least one of broadcasting service and communication service to the user.

It is preferable that the privacy policy is described in at least one of a natural language, XML, SGML, a table and a binary all understandable by a computer.

It is preferable that the privacy policy includes at least one of (a) a kind of the data including privacy of the user, collected by the server, (b) a purpose of collecting the data including privacy of the user, (c) a duration in which the server stores collected data including privacy of the user, (d) indication as to whether the data including privacy of the user is made open to public, (e) indication as to whether the user is allowed to make access to the data including privacy of the user, collected by the server, (f) data which identifies the server, and (g) indication as to whether the server is examined by a third organization with respect to handling data including privacy of a user.

It is preferable that the privacy preference is described in at least one of XML, SGML, a table and a binary all understandable by a computer.

It is preferable that the privacy data administrator administrates the data including privacy of the user in accordance with P3P (Platform for Privacy Preference).

For instance, the terminal device may be comprised of a cellular phone.

In another aspect of the present invention, there is provided a privacy data administrator connected between a server and a terminal of device of a user for administrating data including privacy of the user, including (a) a first unit which acquires a privacy policy from the server, (b) a memory storing a privacy preference established by the user, and (c) a controller which determines whether it is allowed to provide the data including privacy of the user to the server, based on comparison of the privacy preference and the privacy policy to each other.

It is preferable that the privacy data administrator further includes a second unit which, when the controller determines that it is allowed to provide the data including privacy of the user, transmitted from the terminal device, to the server, transmits the data including privacy of the user to the server from the terminal device therethrough.

It is preferable that the privacy data administrator further includes a third unit which receives from the server a request to provide the data including privacy of the user to the server. The third unit, when the controller determines that it is allowed to provide the data including privacy of the user to the server, receives the data from the terminal device, and transmits the data to the server.

It is preferable that the controller, when the controller determines that it is not allowed to provide the data including privacy of the user to the server, outputs data indicative of inconsistency between the privacy preference and the privacy policy.

It is preferable that the privacy data administrator further includes a fourth unit which, when the controller determines that it is not allowed to provide the data including privacy of the user to the server, transmits a first inquiry to the terminal device as to whether it is allowed to provide the data including privacy of the user to the server, and receives a reply from the terminal device.

It is preferable that the fourth unit displays the first inquiry and a reply form to make an answer to the first inquiry, in a display unit of the terminal device.

It is preferable that the fourth unit transmits the first inquiry together with data indicative of inconsistency between the privacy preference and the privacy policy, to the terminal device,

It is preferable that the privacy data administrator further includes a second memory to store the reply, wherein the fourth unit, when the controller has determined that it was not allowed to provide the data including privacy of the user to the server, (a) checks whether a reply having been made in response to an inquiry identical with the first inquiry is stored in the second memory, (b) if the reply is stored in the second memory, does not transmit the inquiry identical with the first inquiry to the terminal device, and (d) treats the reply stored in the second memory as a reply to be made in response to the inquiry.

It is preferable that the second memory stores not only the reply, but also at least one of a duration in which the reply should be stored, data which identifies a user of the terminal device from which the reply was transmitted, and data which identifies the server.

It is preferable that the fourth unit updates the privacy preference of the user, based on the reply having been made in response to the inquiry.

It is preferable that the privacy data administrator further includes a third memory storing therein data indicative of results of comparison of the privacy preference and the privacy policy to each other, and a privacy data filter which revises the data including privacy of the user, in accordance with the privacy preference, based on the data stored in the third memory.

It is preferable that the privacy data administrator further includes a third memory storing therein both data indicative of results of comparison of the privacy preference and the privacy policy to each other, and the reply having been made in response to the inquiry, and a privacy data filter which revises the data including privacy of the user, in accordance with the privacy preference, based on the data stored in the third memory.

It is preferable that the third memory stores data indicative of a kind of the data including privacy of the user, extracted from the privacy policy.

It is preferable that the third memory stores not only the stores data indicative of a kind of the data including privacy of the user, extracted from the privacy policy, but also at least one of a duration in which the data should be stored, data which identifies a user who has the privacy preference, and data which identifies the server having the privacy policy.

For instance, the controller administrates the data including privacy of the user in accordance with P3P (Platform for Privacy Preference).

For instance, the privacy data administrator acts as a gateway through which the server and the terminal device are connected to each other.

In still another aspect of the present invention, there is provided a program for causing a computer to act as the above mentioned privacy data administrator for administrating data including privacy of the user in communication made between a server and a terminal of device of a user.

In yet another aspect of the present invention, there is provided a method of administrating data including privacy of a user in communication made between a server and a terminal device of the user in a system including a server, a user's terminal device and a privacy data administrator connected between the server and the terminal device, including the steps of (a) comparing a privacy policy made by the server and a privacy preference determined by the user to each other, the step (a) being to be carried out by the privacy data administrator, and (b) determining whether it is allowed to provide data including privacy of the user to the server.

It is preferable that the method further includes the steps of, when it is determined that it is not allowed to provide the data including privacy of the user to the server, transmitting a first inquiry to the terminal device as to whether it is allowed to provide the data including privacy of the user to the server, and receiving a reply from the terminal device.

It is preferable that the method further includes the steps of storing the reply made in response to each of various inquiries, when it was determined that it was not allowed to provide the data including privacy of the user to the server, checking whether a reply having been made in response to an inquiry identical with the first inquiry is stored, if the reply is stored therein, not transmitting the inquiry identical with the first inquiry to the terminal device, and treating the reply stored therein as a reply to be made in response to the inquiry.

It is preferable that the method further includes the step of revising the data including privacy of the user in accordance with the privacy preference, based on comparison of the privacy preference to the privacy policy.

It is preferable that the method further includes the step of revising the data including privacy of the user in accordance with the privacy preference, based on both comparison of the privacy preference to the privacy policy and the reply having been made from the terminal device in response to the inquiry.

The advantages obtained by the aforementioned present invention will be described hereinbelow.

In accordance with the present invention, a decision as to whether data including privacy of a user is to be provided to a service provider is made in the system acting as a gateway, located between a server of the service provider and a terminal device of the user, based on comparison of a privacy policy presented by the server of the service provider and a privacy preference having been established in advance by the user. Accordingly, even a terminal device having low performance ability, such as a cellular phone, can make determine whether data including privacy of the user is to be provided to a service provider.

The system in accordance with the present invention has a function of filtering data. Hence, agreement about provision of data including privacy of a user can be kept by distinguishing data which is allowed to be provided to a service provider and data which is not allowed to be provided to a service provider, from each other by virtue of the data-filtering function.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a functional block diagram of a system for administrating data including privacy of a user in communication made between a server and a terminal device of the user, in accordance with the first embodiment of the present invention.

FIG. 2 illustrates an example of a privacy policy in the first embodiment.

FIG. 3 illustrates an example of a privacy preference in the first embodiment.

FIG. 4 is a flow chart showing an operation of the system in accordance with the first embodiment.

FIG. 5 is a functional block diagram of a system for administrating data including privacy of a user in communication made between a server and a terminal device of the user, in accordance with the second embodiment of the present invention.

FIG. 6 illustrates an example of a privacy preference in the second embodiment.

FIG. 7 illustrates an example of a privacy policy in the second embodiment.

FIG. 8 illustrates an example of another privacy policy in the second embodiment.

FIG. 9 is a functional block diagram of a system for administrating data including privacy of a user in communication made between a server and a terminal device of the user, in accordance with the third embodiment of the present invention.

FIG. 10 illustrates an example of data stored in a memory in the second embodiment.

FIG. 11 is a flow chart showing an operation of the system in accordance with the third embodiment.

FIG. 12 illustrates an example of a privacy preference in the third embodiment.

FIG. 13 illustrates an example of a privacy policy in the third embodiment.

FIG. 14 is a functional block diagram of a system for administrating data including privacy of a user in communication made between a server and a terminal device of the user, in accordance with the fourth embodiment of the present invention.

FIG. 15 illustrates an example of data stored in a memory in the fourth embodiment.

FIG. 16 is a functional block diagram of an example of the system in accordance with the fourth embodiment of the present invention.

### DESCRIPTION OF THE PREFERRED EMBODIMENTS

Preferred embodiments in accordance with the present invention will be explained hereinbelow with reference to drawings.

### First Embodiment

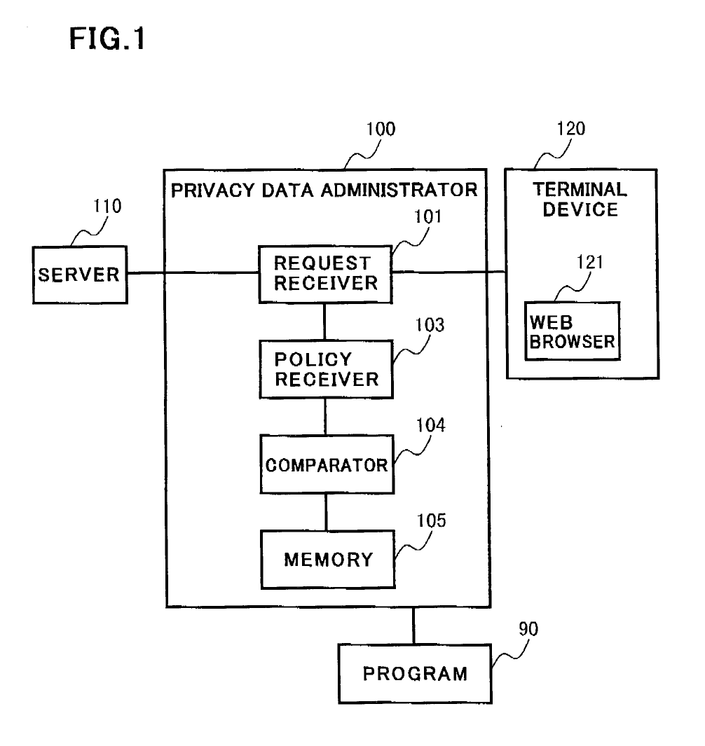

FIG. 1 is a functional block diagram of a system for administrating data including privacy of a user in communication made between a server and a terminal device of the user, in accordance with the first embodiment.

As illustrated in FIG. 1, the system is comprised of a privacy data administrator 100 in which a program 90 for administrating privacy data is installed, a server 110 of a service provider, and a user's terminal device 120 in which a web browser 121 is installed.

In the specification, a service provider is defined as a person or a company who provides service to a user in accordance with data including privacy of the user For instance, a service provider provides broadcasting service, communication service and the like to a user.

In the specification, a user is defined as a person or a company who provides data including privacy of itself, and receives service from a service provider in response. Such data including privacy of a user includes, for instance, data which identifies a user, an address of a user, an age of a user, a telephone number of a user, data which identifies a terminal device of a user, data indicative of environment of a terminal device of a user (such as a hardware connected to the terminal device), data indicative of network environment of a terminal device of a user, and data indicative of programs installed in a terminal device of a user.

The privacy data administrator 100 is located between the server 110 of a service provider and the terminal device 120 of a user, and administrates data including privacy of the user in communication made between the server 110 and the terminal device 120.

In the first embodiment, the privacy data administrator 100 receives a request, transmitted from the server 110, to provide data including privacy of a user to the server 110, and judges whether such data is allowed to provide to the server 110, based on a privacy policy presented from the server 110 and a privacy preference having been established in advance by the user. When it is judged that such data is allowed to be provided to the server 110, the privacy data administrator 100 transmits data received from the terminal device 120 of the user, to the server 110.

A privacy policy is described in a language understandable by a computer, such as XML (extensible Markup Language), in accordance with a certain standard such as P3P (Platform for Privacy Preference). A privacy policy includes, for instance, a kind of data including privacy of said user, collected by the server 110, a purpose of collecting data including privacy of a user, a duration in which the server 110 stores collected data including privacy of said user, indication as to whether data including privacy of a user is made open to public, indication as to whether a user is allowed to make access to data including privacy of the user, collected by the server 110, data which identifies the server 110, and indication as to whether the server 110 is examined by a third organization with respect to handling data including privacy of a user.

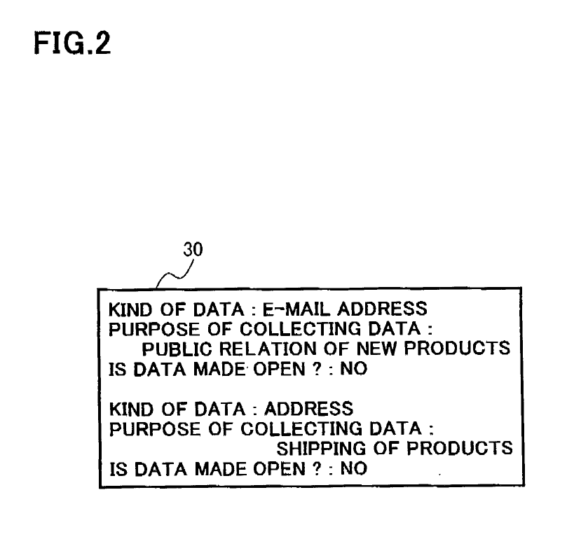

An example of a privacy policy 30 is shown in FIG. 2.

A privacy preference is defined as criteria in accordance with which data including privacy of a user is judged as to whether it is allowed to be provided to a service provider or not.

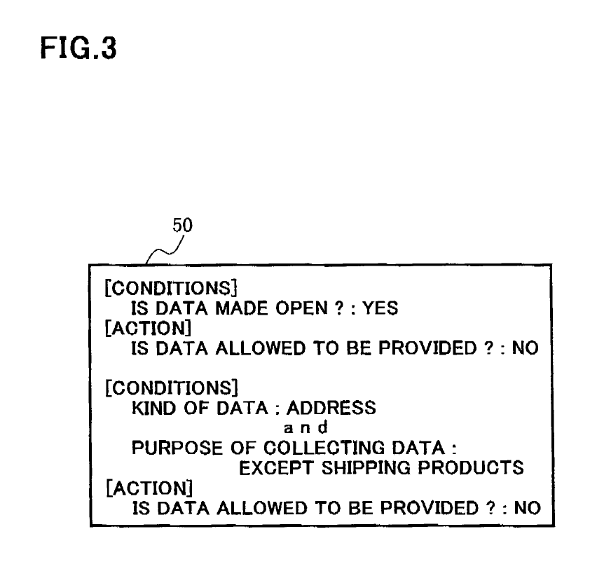

An example of a privacy preference 50 is shown in FIG. 3. The privacy preference 50 is described in such a form that it is possible to judge whether the privacy policy 30 is acceptable to a user.

The privacy data administrator 100 receives the privacy policy 30 from the server 110 and further receives the privacy preference 50 from the terminal device 120. The privacy data administrator 100 compares the privacy policy 30 and the privacy preference 50 to each other, and judges whether the privacy policy 30 is acceptable to a user of the terminal device 120.

With reference back to FIG. 1, the privacy data administrator 100 is comprised of a programmable central processing unit (CPU), for instance. Specifically, the privacy data administrator 100 is designed to include a request receiver 101 which receives a request from the server 110 to provide data including privacy of a user to the server 110, a policy receiver 103 which detects the privacy policy 30 and receives it from the server 110, a comparator 104 which compares the privacy policy 103 received at the policy receiver 103, to the privacy preference 50, and judges whether the privacy policy 30 is consistent with the privacy preference 50, and a memory 105 storing the privacy preference 50 therein.

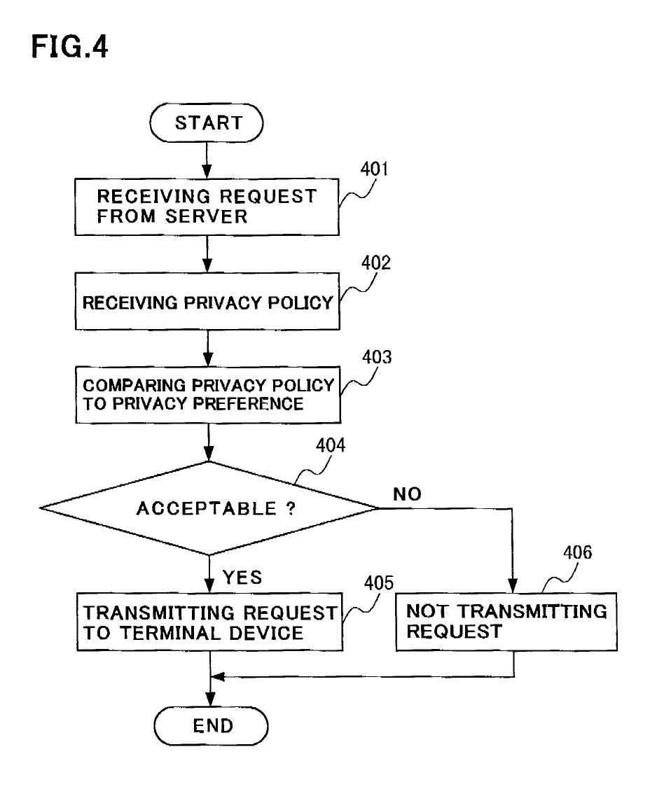

FIG. 4 is a flow chart showing an operation of the privacy data administrator 100 in accordance with the first embodiment.

The request receiver 101 receives a request from the server 110 to provide data including privacy of a user to the server 110, in step 401. Data including privacy of a user includes, for instance, data indicative of a location of the terminal device 120.

On receipt of the request from the server 110, the request receiver 101 transmits data relating to the server 110, to the policy receiver 103.

On receipt of data relating to the server 110 from the request receiver 101, the policy receiver 103 acquires the privacy policy 30 from the server 110, in step 402.

The comparator 104 compares the privacy policy 30 acquired by the policy receiver 103, to the privacy preference 50, in step 403, and judges whether the privacy policy 30 is acceptable to a user, in step 404.

If the privacy policy 30 is judged to be acceptable to a user (YES in step 404), the privacy data administrator 100 transmits the request received from the server 110, to the user's terminal device 120, in step 405.

In response, a user transmits requested data about his/her privacy to the privacy data administrator 100 through his/her terminal device 120 by virtue of a client program, for instance.

If the privacy policy 30 is judged to be unacceptable to a user (NO in step 404), the privacy data administrator 100 does not transmit the request to the user's terminal device 120, in step 406.

The memory 105 stores the privacy preference 50 of each of users, and provides the privacy preference 50 in response to a request transmitted from the comparator 104.

In accordance with the above-mentioned system, the privacy data administrator 100 judges whether it is allowable to provide data including privacy of a user of the terminal device 120, to the server 110 of the service provider, based on both the privacy policy 30 provided from the service provider and the privacy preference 50 established by the user. Accordingly, it would be possible for a terminal device having low performance ability to judge whether data including privacy of a user is allowable to be provided to a service provider.

### Second Embodiment

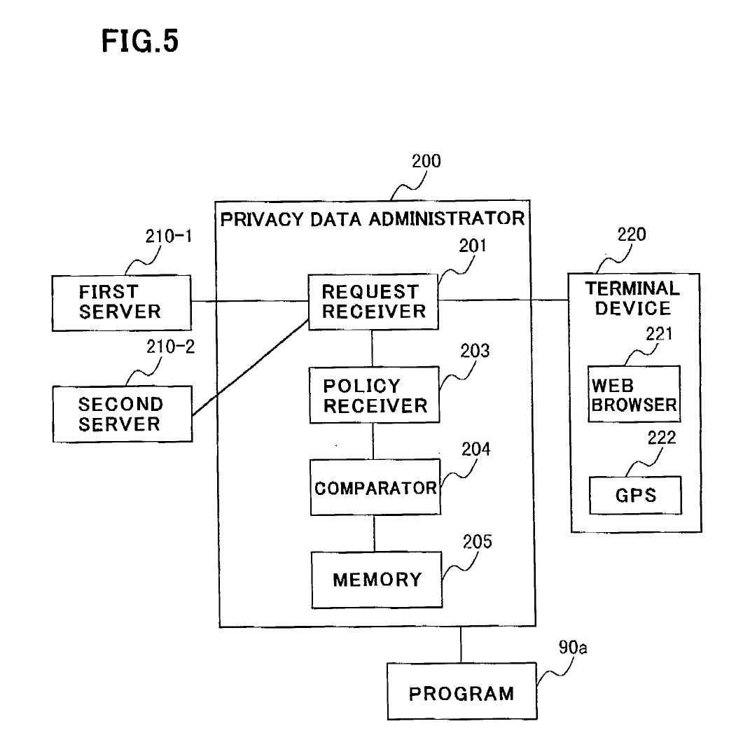

FIG. 5 is a functional block diagram of a system for administrating data including privacy of a user in communication made between a server and a terminal device of the user, in accordance with the second embodiment.

As illustrated in FIG. 5, the system is comprised of a privacy data administrator 200 in which a program 90a for administrating privacy data is installed, a first server 210-1 of a first service provider, a second server 210-2 of a second service provider, and a user's terminal device 220.

The privacy data administrator 200 is comprised of a programmable central processing unit (CPU), for instance. Specifically, the privacy data administrator 200 is designed to include a request receiver 201 which receives a request from the first server 210-1 and/or the second server 210-2 to provide data including privacy of a user to the first server 210-1 and/or the second server 210-2, a policy receiver 203 which detects the privacy policy 30 and receives it from the first server 210-1 and/or the second server 210-2, a comparator 204 which compares the privacy policy 203 received at the policy receiver 203, to the privacy preference 50, and judges whether the privacy policy 30 is consistent with the privacy preference 50, and a memory 205 storing the privacy preference 50 therein.

The user's terminal device 220 is comprised of a cellular phone or a personal computer, for instance. The terminal device 220 includes a web browser 221 installed therein, and a device for detecting a location of the terminal device 220, such as GPS 222.

In the second embodiment, the privacy data administrator 200 administrates data indicative of a location of the user's terminal device.220.

The first and second service providers track and analyze data indicative of a location of the terminal device 220.

Data including privacy of a user of the terminal device 220 is provided to the first and second service providers through the privacy data administrator 200.

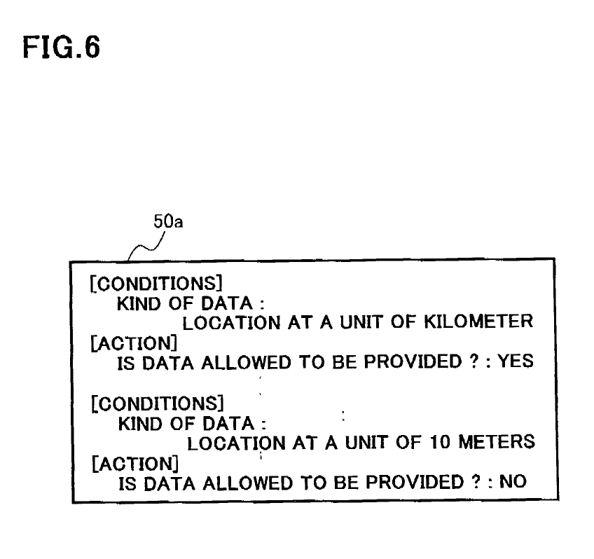

FIG. 6 shows a privacy preference 50a having been established in advance by a user of the terminal device 220. As shown in FIG. 6, in accordance with the privacy preference 50a, it is allowed to provide data indicative of a location of a user at a unit of kilometer, to the first and second service providers, but it is not allowed to provide data indicative of a location of a user at a unit of ten meters, to the first and second service providers.

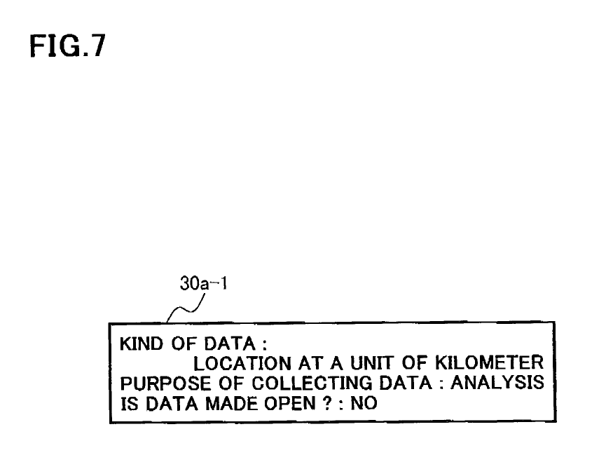

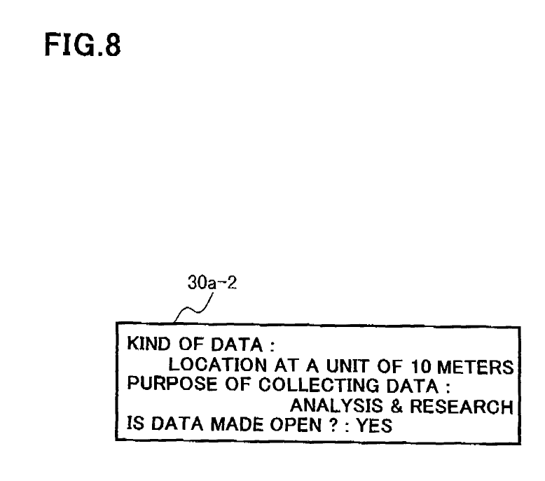

The first service provider has a privacy policy 30a-1 as illustrated in FIG. 7, and the second service provider has a privacy policy 30a-2 as illustrated in FIG. 8.

When the first server 210-1 of the first service provider transmits a request to provide data indicative of a location of a user of the terminal device 220, to the request receiver 201, the privacy data administrator 200 compares the privacy policy 30a-1 of the first service provider to the privacy preference 50a of the user of the terminal device 220, and judges that it is allowable to provide data indicative of a location of a user of the terminal device 220, to the first server 210-1. Then, the request receiver 201 requests the terminal device 220 to transmit data indicative of a location of the terminal device 220 to the request receiver 201. On receipt of the data, the request receiver 201 transmits the data to the first server 210-1.

In contrast, when the second server 210-2 of the second service provider transmits a request to provide data indicative of a location of a user of the terminal device 220, to the request receiver 201, the privacy data administrator 200 compares the privacy policy 30a-2 of the second service provider to the privacy preference 50a of the user of the terminal device 220, and judges that it is not allowable to provide data indicative of a location of a user of the terminal device 220, to the second server 210-2. Accordingly, the request receiver 201 does not request the terminal device 220 to transmit data indicative of a location of the terminal device 220 to the request receiver 201, and further does not transmit the data to the second server 210-2.

In accordance with the above-mentioned system, the privacy data administrator 200 judges whether it is allowable to provide data indicative of a location of a user of the terminal device 220, to the first server 210-1 and/or the second server 210-2, based on both the privacy policies 30a-1 and 30a-2 provided from the first and second service providers and the privacy preference 50a established by the user. Accordingly, it would be possible for a terminal device having low performance ability to judge whether data indicative of a location of a user is allowable to be provided to a service provider.

### Third Embodiment

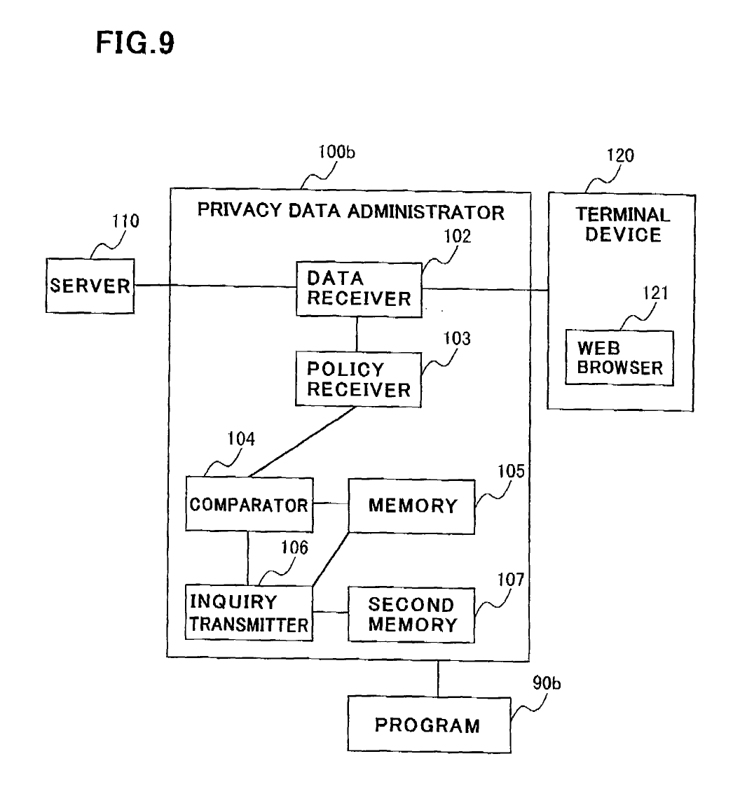

FIG. 9 is a functional block diagram of a system for administrating data including privacy of a user in communication made between a server and a terminal device of the user, in accordance with the third embodiment.

As illustrated in FIG. 9, the system in accordance with the third embodiment is comprised of a privacy data administrator 100b in which a program 90b for administrating privacy data is installed, a server 110 of a service provider, and a user's terminal device 120 in which a web browser 121 is installed.

In the third embodiment, the privacy data administrator 100b receives data including privacy of a user of the terminal device 120 which data is to be transmitted to the server 110 from the terminal device 120, and judges whether it is allowable to provide the received data to the server 110, based on a privacy policy 30b of a service provider and a privacy preference 50b established by a user. When it is judged allowable to transmit the received data to the server 110, the privacy data administrator 100b transmits the received data to the server 110.

With reference back to FIG. 9, the privacy data administrator 100b is comprised of a data receiver 102 which receives data including privacy of a user from the terminal device 120, a policy receiver 103 which detects the privacy policy 30b and receives it from the server 110, a comparator 104 which compares the privacy policy 30b received at the policy receiver 103, to the privacy preference 50b, and judges whether the privacy policy 30b is consistent with the privacy preference 50b, a memory 105 storing the privacy preference 50b therein, an inquiry transmitter 106 which transmits an inquiry to the terminal device 120 as to whether agreement is to be made or not, in accordance with the results of comparison carried out by the comparator 104, and a second memory 107 storing a reply made in response to the inquiry.

When data including privacy of a user is going to be transmitted to the server 110 from the terminal device 120, the data receiver 102 receives the data, and stops the data from being transmitted to the server 110. Data including privacy of a user is comprised of, for instance, data input into a form of a web browser and thereafter transmitted to a web.

On receipt of data from the terminal device 120, the data receiver 102 transmits data relating to the server 110 to which the received data is directed, to the policy receiver 103.

On receipt of the data from the data receiver 102, the policy receiver 103 receives a privacy policy 30b from the server 110.

The comparator 104 compares the privacy policy 30b acquired by the policy receiver 103, to the privacy preference 50b, and judges whether the privacy policy 30b is acceptable to a user.

If the privacy policy 30b is judged to be unacceptable to a user, the comparator 104 outputs not only the results of comparison, but also data indicative of inconsistency between the privacy policy 30b and the privacy preference 50b.

The memory 105 stores the privacy preference 50b of each of users, and provides the privacy preference 50b to the comparator 104 in response to a request transmitted from the comparator 104.

When the comparator 104 judges that the privacy policy 30b is not acceptable to a user, the inquiry transmitter 106 transmits an inquiry to a user of the terminal device 120 to inquire a user of whether the data should not be provided to the server 110, or he/she does not really receive service from the service provider.

The inquiry is transmitted to the terminal device 120, for instance, when the terminal device 120 is making access to the server 110 through the web browser 121. The inquiry in the form of HTML (Hyper Text Markup Language) document is transmitted to and displayed in the web browser 121.

The HTML document may be accompanied with a response form used for making a response to the inquiry may be accompanied, in which case, the HTML document together with the response form is displayed in the web browser 121 of the terminal device 120.

The inquiry may be accompanied with data indicative of inconsistency between the privacy preference 50b and the privacy policy 30b.

If a user makes a response to the inquiry that it is allowed to provide the data to the server 110 in contradiction to the results of comparison having been carried out by the comparator 104, the inquiry transmitter 106 revises the privacy preference 50b stored in the memory 105 such that the privacy policy 30b of the server 110 will be accepted to a user.

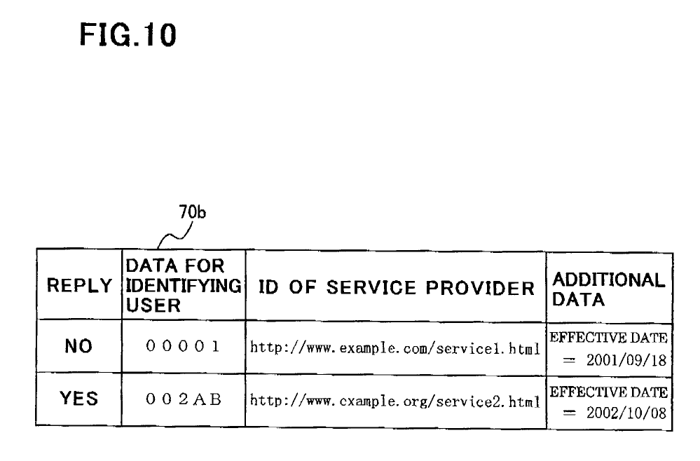

As an alternative, as illustrated in FIG. 10, the inquiry transmitter 106 may store a reply made in response to the inquiry, data identifying a user, such as an identifier, data identifying service provided a service provider, such as URL, and additional data indicative of effective duration of a reply made in response to the inquiry, in the second memory 107 as a reply 70b made in response to the inquiry.

The inquiry transmitter 106 can avoid transmission of unnecessary inquiries by retrieving past replies stored in the second memory 107, before transmitting an inquiry to the terminal device 120 of a user.

In other words, when it is judged that it is not allowed to provide data including privacy of a user of the terminal device 120 to the server 110, the inquiry transmitter 106 retrieves the second memory 107 to find a reply made in response to an inquiry identical with the inquiry which the inquiry transmitter 106 is going to transmit to the terminal device 120. If such a reply is stored in the second memory 107, the inquiry transmitter 106 does not transmit the inquiry to the terminal device 102, and treats the reply stored in the second memory 107, as a reply to the inquiry.

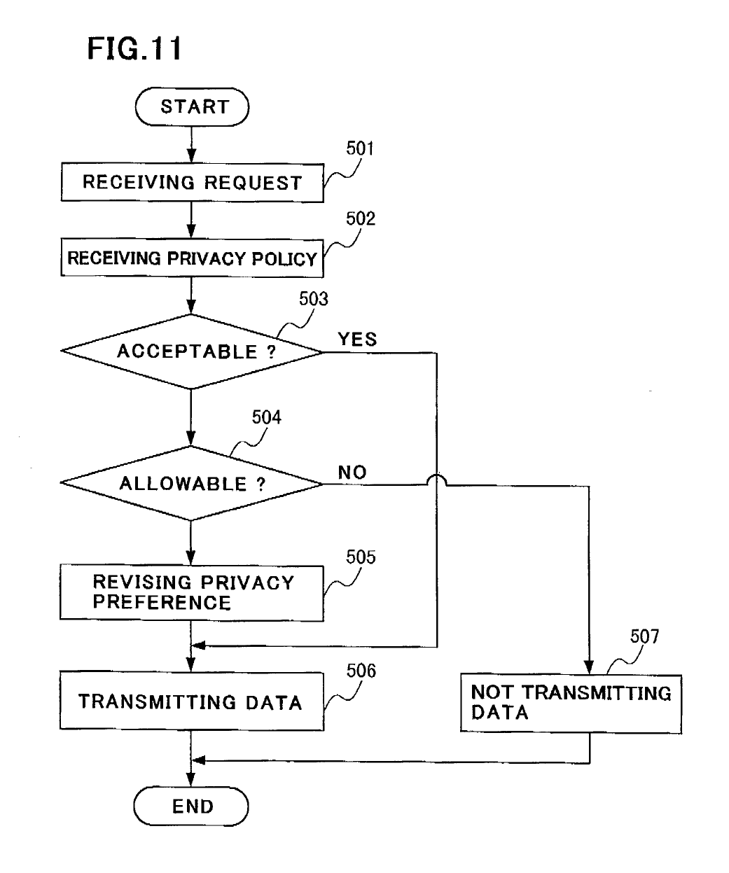

The inquiry transmitter 106 has a function of revising the privacy preference 50b. FIG. 11 is a flow chart showing an operation of revising the privacy reference 50b, carried out by the inquiry transmitter 106. Hereinbelow is explained revision of the privacy reference 50b to be carried out by the inquiry transmitter 106, with reference to FIG. 11.

The data receiver 102 in the privacy data administrator 100b receives a request from the terminal device 120 to transmit data including privacy of a user of the terminal device 120 to the server 110, in step 501.

On receipt of the request, the policy receiver 103 transmits a request to the server 110 to transmit the privacy policy 30b of the server 110 to the privacy data administrator 100b, and the policy receiver 103 receives the privacy policy 50b, in step 502.

The comparator 104 compares the privacy policy 30b to the privacy preference 50b of the user to thereby judge whether the privacy policy 30b is acceptable to the user, in step 503.

If the comparator 104 judges that the privacy policy 30b is acceptable to the user (YES in step 503), the privacy data administrator 100b transmits the data having been received from the terminal device 120, to the server 110, in step 506.

If the comparator 104 judges that the privacy policy 30b is not acceptable to the user (NO in step 503), the inquiry transmitter 106 transmits an inquiry to the terminal device 120 as to whether it is allowable to provide the data to the server 110, in step 504.

If the user makes a reply to the inquiry that it is not allowable to provide the data to the server 110 (NO in step 504), the privacy data administrator 100b does not transmit the data to the server 110, in step 507.

If the user makes a reply to the inquiry that it is allowable to provide the data to the server 110 (YES in step 504), the privacy data administrator 100b revises the privacy preference 50b in step 505, and transmits the data to the server 110, in step 506.

As mentioned above, after the data has been transmitted to the server 110 in the above-mentioned way, the privacy preference 50b is changed into a revised one. Accordingly, when the user transmits the data to the server 110 again, the comparator 104 judges that the privacy policy 30b is acceptable to the user, because the privacy preference 50b has been already revised. Hence, the inquiry transmitter 106 does not transmit the same inquiry twice to the terminal device 120.

The third embodiment is different from the first and second embodiments in that the server 110 of a service provider transmits a request to the privacy data administrator 100 to transmit data including privacy of a user to the server 100, in the first and second embodiments, whereas the terminal device 120 makes explicit access to the server 110 in the third embodiment. Similarly to the first and second embodiments, the privacy data administrator 100b in the third embodiment judges whether it is allowable to provide data including privacy of a user to the server 110, based on the privacy policy 30b and the privacy preference 50b.

The privacy data administrator 100b in accordance with the third embodiment is designed to judge whether it is allowable to provide data received from the terminal device 120. Hence, the privacy data administrator 100b is designed to include the inquiry transmitter 106 and the second memory 107, and thus, even if the comparator 104 judges that the privacy policy 30b of the server 110 is not acceptable to a user, based on comparison with the privacy preference 50b, the privacy data administrator 100b can make an inquiry to a user of the terminal device 120 as to whether it is allowable to provide data to the server 110.

Hereinbelow is explained an example of an operation of the privacy data administrator 100b.

It is assumed that a user inputs data including his/her privacy into HTML form through the web browser 121, and transmits the thus input data to the server 110. It is also assumed that the thus input data includes an e-mail address of the user.

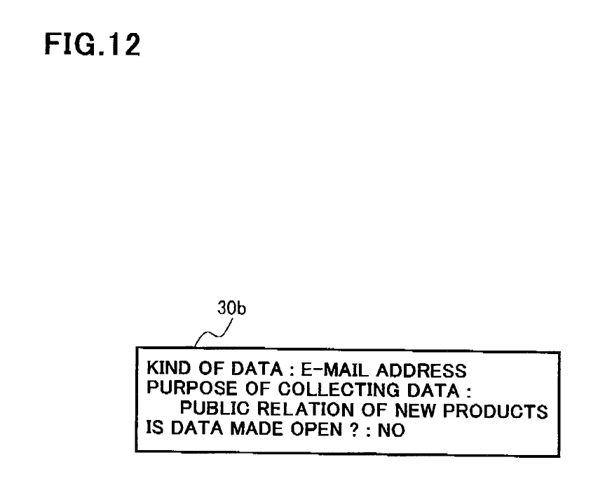

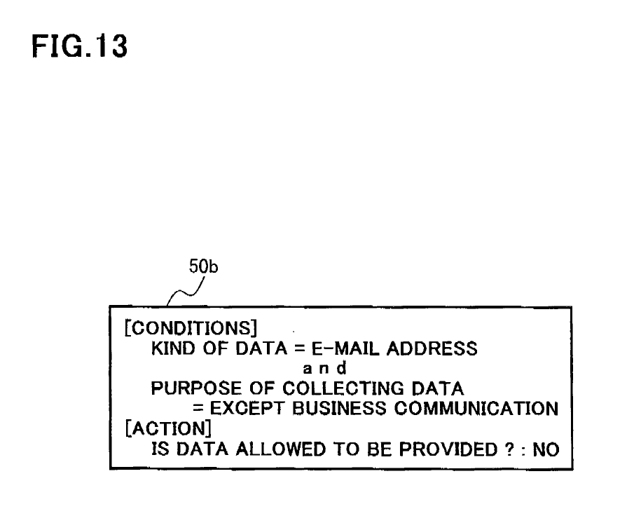

When the data receiver 102 receives the data from the terminal device 120, the policy receiver 103 receives the privacy policy 30b from the server 110. Then, the comparator 104 compares the privacy policy 30b to the privacy preference 50b. Herein, the privacy policy 30b is as shown in FIG. 12, and the privacy preference 50b is as shown in FIG. 13.

Since the purpose of collecting data, described in the privacy policy 30b, is not consistent with the purpose of collecting data, described in the privacy preference 50b, the comparator 104 judges that it is not allowable to provide the data to the server 110. Then, the inquiry transmitter 106 of the privacy data administrator 100b makes an inquiry to the web browser 121 of the terminal device 120. The inquiry is in the form of HTML document, and reads “Though the privacy policy of the server says that the purpose of collecting e-mail addresses is to transmit public relation of new products, do you provide your privacy data to the server?”.

If the user makes a reply that the data should not be provided to the server 110, the privacy data administrator 100b does not transmit the data to the server 110. In contrast, if the user makes a reply that it is allowable to provide the data to the server 110, the privacy data administrator 100b transmits the data to the server 110.

When the user makes a reply that it is allowable to provide the data to the server 110, the inquiry transmitter 106 revises the privacy preference 50b stored in the memory 105, in accordance with the reply made by the user. That is, the inquiry transmitter 106 revises the privacy preference 50b such that the privacy preference 50b allows to provide data to the server which data includes an e-mail address of a user, to be used only for transmitting public relation of new products to the user. As a result, the comparator 104 judges whether is it allowable to provide data to the server 110, based on the thus revised privacy preference 50b, and hence, the privacy data administrator 100b provides data to the server 110 without making an inquiry to the user of the terminal device 120.

In accordance with the above-mentioned system, the privacy data administrator 100b judges whether it is allowable to provide data including an e-mail address of a user of the terminal device 120, to the server 110, based on both the privacy policy 30b and the privacy preference 50b.

Even if it is judged that the privacy policy 30b is not acceptable to a user, based on the privacy preference 50b, the inquiry transmitter 106 can make an inquiry to a user as to whether it is allowable to provide data including privacy of a user to the server 110. In addition, the inquiry transmitter 106 revises the privacy preference 50b stored in the second memory 107, in accordance with a reply made by the user in response to the inquiry.

Accordingly, it would be possible for a terminal device having a simple web browser to judge whether data including an e-mail address of a user is allowable to be provided to a service provider.

### Fourth Embodiment

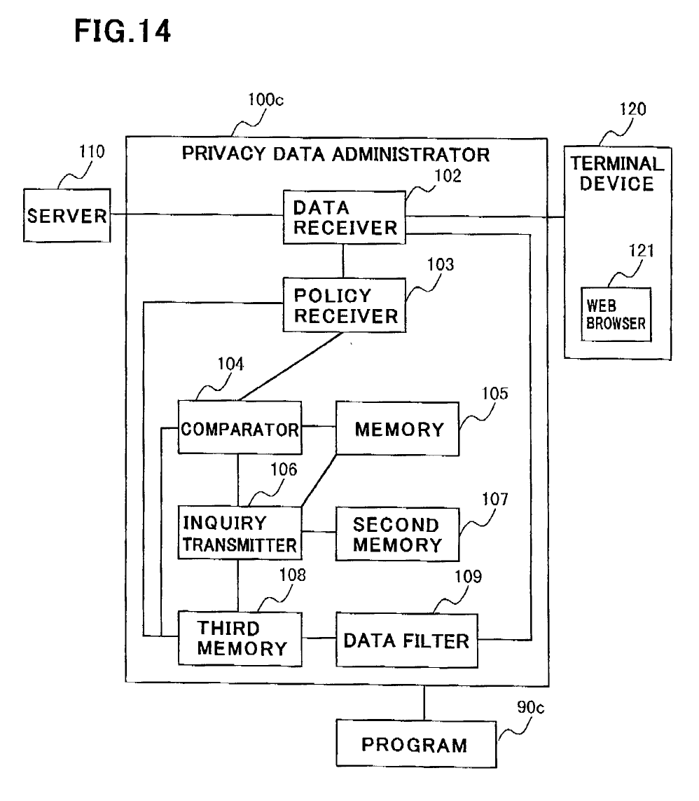

FIG. 14 is a functional block diagram of a system for administrating data including privacy of a user in communication made between a server and a terminal device of the user, in accordance with the fourth embodiment.

As illustrated in FIG. 14, the system in accordance with the fourth embodiment is comprised of a privacy data administrator 100c in which a program 90c for administrating privacy data is installed, a server 110 of a service provider, and a user's terminal device 120 in which a web browser 121 is installed.

With reference back to FIG. 14, the privacy data administrator 100c is comprised of a data receiver 102 which receives data including privacy of a user from the terminal device 120, a policy receiver 103 which detects the privacy policy 30 and receives it from the server 110, a comparator 104 which compares the privacy policy 30 received at the policy receiver 108, to the privacy preference 50, and judges whether the privacy policy 30 is consistent with the privacy preference 50, a memory 105 storing the privacy preference 50 therein, an inquiry transmitter 106 which transmits an inquiry to the terminal device 120 as to whether agreement is to be made or not, in accordance with the results of comparison carried out by the comparator 104, a second memory 107 storing a reply made in response to the inquiry, a third memory 108 storing an agreement about privacy of a user, made between the user and a service provider as a result of the inquiry transmitted from the inquiry transmitter 106, and a data filter 109 allowing data to pass therethrough in accordance with an agreement stored in the third memory 108.

The system in accordance with the fourth embodiment is different from the system in accordance with the third embodiment in including the third memory 108 and the data filter 109.

The system in accordance with the third embodiment does not have a function of carrying out an agreement having been made between a user and a service provider. The system in accordance with the fourth embodiment carries out an agreement having been made between a user and a service provider, by means of the third memory 108 and the data filter 109.

The third memory 108 is empowered by he comparator 104 when the comparator 104 judges that the privacy policy 30 is acceptable to a user. As an alternative, the third memory 108 is empowered by the inquiry transmitter 106 when the inquiry transmitter 106 receives a reply that the privacy policy 30 is acceptable, from a user in response to the inquiry having been transmitted from the inquiry transmitter 106 to the user.

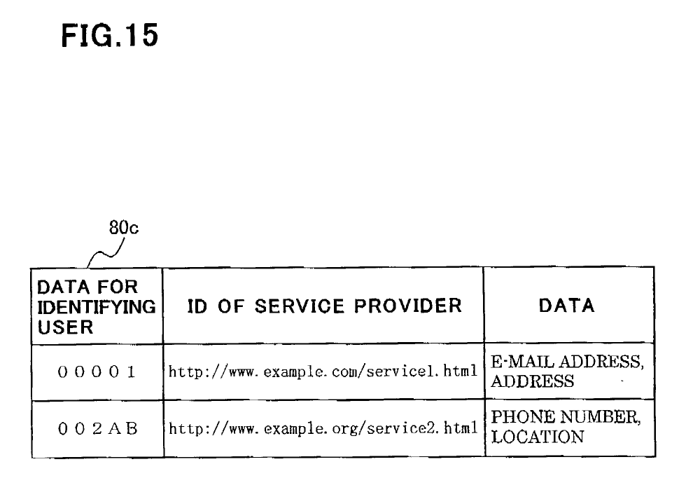

Then, the third memory 108 receives the privacy policy 30 of the server 110 from the policy receiver 103, and extracts a kind of data collected by the server 110, out of the privacy policy 30. Then, as illustrated in FIG. 15, the third memory 108 stores therein the thus extracted kind of data together with an identifier of a user and an identifier of the server 110 (URL or an identifier of a service provider) as an agreement 80c.

The third memory 108 may store the thus extracted kind of data together with a duration in which the extracted data should be stored, data identifying a user, or data identifying the server 110, such as URL.

The data filter 109 is made start by the data receiver 102. The data filter 109 removes data not covered by the agreement, among data to be provided to the server 110 from the terminal device 120. For instance, if the privacy policy 30 declares that data indicative of an e-mail address is collected, and further if the data receiver 102 receives data including an address and an e-mail address of a user, the data filter 109 removes an address of a user

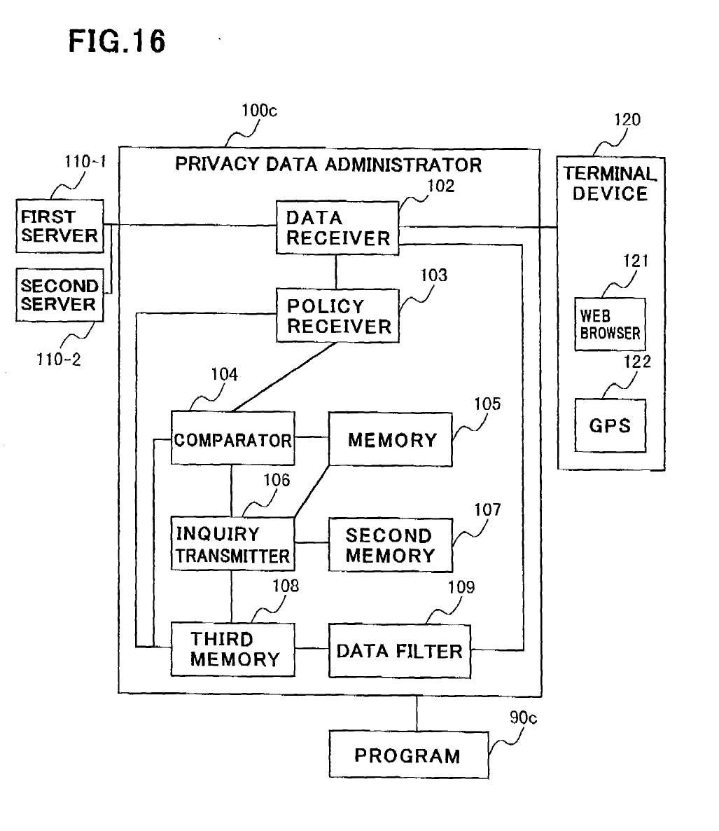

FIG. 16 is a functional block diagram of an example of the system in accordance with the fourth embodiment. In this example, the privacy data administrator 100c acts as a gateway.

As illustrated in FIG. 16, the system is comprised of a privacy data administrator 100c in which a program 90a for administrating privacy data is installed, a first server 110-1 of a first service provider, a second server 110-2 of a second service provider, and a user's terminal device 120.

The privacy data administrator 100c in the example has the same structure as that of the privacy data administrator 100c illustrated in FIG. 14.

The user's terminal device 120 is comprised of a cellular phone or a personal computer, for instance. The terminal device 120 includes a web browser 121 installed therein, and a device for detecting a location of the terminal device 120, such as GPS 122.

Each time a user of the terminal device 120 makes access to the first and/or second servers 110-1 and 110-2 through the web browser 121, data indicative of a location of the user at a unit of 10 meters, detected by GPS 122, is transmitted to the first and/or second servers 110-1 and 110-2.

The user of the terminal device 120 has such a privacy preference 50a as illustrated in FIG. 6, and the first provider has such a privacy policy 30a-1 as illustrated in FIG. 7.

It is assumed that the terminal device 120 makes access to the first server 110-1. Since the privacy policy 30a-1 matches with the privacy preference 50a, the comparator 104 judges that it is allowable to provide data including privacy of the user to the first and/or second server(s) 110-1 and 110-2.

In the above-mentioned third embodiment, even if the first service provide requests data indicative of a location of the user at a unit of kilometer, the terminal device 120 may transmit data indicative of a location of the user at a unit of 10 meters, to the first server 110-1.

In the example system illustrated in FIG. 16, the agreement that only data indicative of a location of a user at a unit of kilometer may be provided to a service provider is stored in the third memory 108. Accordingly, the data filter 109 revises data indicative of a location of a user at a unit of 10 meters into data indicative of a location of a user at a unit of kilometer. The thus revised data is transmitted to the first and/or second servers 110-1 and 110-2 from the privacy data administrator 100c.

As explained above, the privacy data administrator 100c supports the agreement made between the terminal device 120 and the first and/or second servers 110-1 and 110-2 as to communication of data including privacy of the user, and filters data which is to be provided to the first and/or second servers 110-1 and 110-2 from the terminal device 120, in accordance with the agreement. Accordingly, only data covered by the agreement is provided to the first and/or second servers 110-1 and 110-2.

The above-mentioned embodiments and examples may be carried out alone or in combination.

For instance, hereinbelow is explained a combination of the second embodiment and the example of the third embodiment.

In the second embodiment, the server 110 having the privacy policy 30 which does not match with the privacy preference 50 of a user cannot obtain data indicative of a location of the user. In this combination, the server 110 can have such data by applying the function of making an inquiry to a user, having been explained in the example of the third embodiment, to the server 110.

For instance, when a user of the terminal device 120 makes access to the server 110 of a service provider through the web browser 121, the service provider informs the user of services provided by the service provider. Then, the user transmits data indicative of a location of the user to the server 110. However, such data does not match with the privacy preference 50, the inquiry transmitter 106 transmits an inquiry to the user as to whether it is allowable to provide the data to the server 110. If the user makes a reply that it is allowable to provide the data to the server 110, the inquiry transmitter 106 revises the privacy preference 50 such that the data matches with the privacy preference 50. Hereinafter, the server 110 is able to obtain data indicative of a location of a user without necessity of the inquiry transmitter 106 to make an inquiry to the user.

When the privacy data administrator 100c receives a request to provide data indicative of a location of a user, to the server 110, the inquiry transmitter 106 may transmit an inquiry to the user of the terminal device 120 as to whether it is allowable to provide such data to the server 110, if the privacy policy 30 does not match with the privacy preference 50.

In the above-mentioned embodiments and examples, data including privacy of a user is administrated in accordance with P3P. However, such data may be administrated in accordance with rules other than P3P.

The above-mentioned privacy preference may be described in a natural language, XML, SGML, a table and a binary alone or in combination, all understandable by a computer. In addition, the privacy policy may include at least one of (a) a kind of data including privacy of a user, collected by a server, (b) a purpose of collecting data including privacy of a user, (c) a duration in which a server stores the collected data including privacy of a user, (d) indication as to whether data including privacy of a user is made open to public, (e) indication as to whether a user is allowed to make access to data including privacy of a user, collected by a server, (f) data which identifies a server, and (g) indication as to whether a server is examined by a third organization with respect to handling data including privacy of a user.

Similarly, the above-mentioned privacy preference may be described in XML, SGML, a table and a binary alone or in combination, all understandable by a computer,

The systems in accordance with the above-mentioned embodiments and examples may be realized by loading the computer programs 90, 90a, 90b or 90c into a memory of a computer. Herein, the computer programs 90, 90a, 90b and 90c accomplish functions of the request receiver 101, the data receiver 102, the policy receiver 103, the comparator 104, the inquiry transmitter 106, and the data filter 109 in the privacy data administrators 100, 200, 100b and 100c.

The computer programs 90, 90a, 90b and 90c may be presented through a recording medium readable by a computer.

In the specification, the term “recording medium” means any medium which can record data therein.

The term “recording medium” includes, for instance, a disk-shaped recorder such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk, a memory chip such as RAM (Random Access Memory) or ROM (Read Only Memory), EPROM (Erasable Programmable Read Only Memory), REPROM (Electrically Erasable Programmable Read Only Memory), smart media (Registered Trade Mark), a flush memory, a rewritable card-type ROM such as a compact flush card, a hard disk, and any other suitable means for storing a program therein.

A recording medium storing the above-mentioned program may be accomplished by programming the functions with a programming language readable by a computer, and recording the program in a recording medium such as mentioned above.

A hard disc equipped in a server may be employed as a recording medium. It is also possible to accomplish the recording medium in accordance with the present invention by storing the above-mentioned computer program in such a recording medium as mentioned above, and reading the computer program by other computers through a network.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-324976 filed on Oct. 23, 2001 including specification, claims, drawings and summary is incorporated herein by reference in its entirety.

What is claimed is:

1. A system for administrating data including privacy of a user in communication made between a server and a terminal device of said user, comprising:
(a) a server;
(b) a terminal device owned by said user; and
(c) a privacy data administrator connected between said server and said terminal device which privacy data administrator compares a privacy policy made by said server and a privacy preference determined by said user to each other, and determines whether it is allowed to provide data including privacy of said user to said server.

2. The system as set forth in claim 1, wherein said privacy data administrator allows said data including privacy of said user to be provided to said server from said terminal device therethrough, when said privacy data administrator determines that it is allowed to provide said data to said server.

3. The system as set forth in claim 1, wherein said privacy data administrator allows a request transmitted from said server for providing said data including privacy of said user to said server, to be transmitted to said terminal device therethrough, when said privacy data administrator determines that it is allowed to provide said data to said server.

4. The system as set forth in claim 1, wherein said privacy data administrator, when said privacy data administrator determines that it is not allowed to provide said data including privacy of said user to said server, transmits a first inquiry to said terminal device as to whether it is allowed to provide said data including privacy of said user to said server, and receives a reply from said terminal device.

5. The system as set forth in claim 4, wherein said privacy data administrator (a) stores said reply made in response to each of various inquiries, (b) when said privacy data administrator has determined that it was not allowed to provide said data including privacy of said user to said server, checks whether a reply having been made in response to an inquiry identical with said first inquiry is stored therein, (c) if said reply is stored therein, does not transmit said inquiry identical with said first inquiry to said terminal device, and (d) treats said reply stored therein as a reply to be made in response to said inquiry.

6. The system as set forth in claim 1, wherein said privacy data administrator revises said data including privacy of said user in accordance with said privacy preference, based on comparison of said privacy preference to said privacy policy, and provides the thus revised data to said server.

7. The system as set forth in claim 4, wherein said privacy data administrator revises said data including privacy of said user in accordance with said privacy preference, based on both comparison of said privacy preference to said privacy policy and said reply having been made from said terminal device in response to said inquiry, and provides the thus revised data to said server.

8. The system as set forth in claim 1, wherein said data including privacy of said user includes at least one of (a) data which identifies said user, (b) an address of said user, (c) an age of said user, (d) a telephone number of said user, (e) data which identifies said terminal device of said user, (f) data indicative of environment of said terminal device, (g) data indicative of network environment of said terminal device, and (h) data indicative of programs installed in said terminal device.

9. The system as set forth in claim 1, wherein said privacy data administrator includes a device which can identify a location of said terminal device, and wherein said data including privacy of said user includes at least one of (a) data which identifies said user, (b) an address of said user, (c) an age of said user, (d) a telephone number of said user, (e) data which identifies said terminal device of said user, (f) data indicative of environment of said terminal device, (g) data indicative of network environment of said terminal device, (h) data indicative of programs installed in said terminal device, and (i) data indicative of a location of said terminal device.

10. The system as set forth in claim 1, wherein said server provides at least one of broadcasting service and communication service to said user.

11. The system as set forth in claim 1, wherein said privacy policy is described in at least one of a natural language, XML, SGML, a table and a binary all understandable by a computer.

12. The system as set forth in claim 1, wherein said privacy policy includes at least one of (a) a kind of said data including privacy of said user, collected by said server, (b) a purpose of collecting said data including privacy of said user, (c) a duration in which said server stores collected data including privacy of said user, (d) indication as to whether said data including privacy of said user is made open to public, (e) indication as to whether said user is allowed to make access to said data including privacy of said user, collected by said server, (f) data which identifies said server, and (g) indication as to whether said server is examined by a third organization with respect to handling data including privacy of a user.

13. The system as set forth in claim 1, wherein said privacy preference is described in at least one of XML, SGML, a table and a binary all understandable by a computer.

14. The system as set forth in claim 1, wherein said privacy data administrator administrates said data including privacy of said user in accordance with P3P (Platform for Privacy Preference).

15. The system as set forth in claim 1, wherein said terminal device is comprised of a cellular phone.

16. A privacy data administrator connected between a server and a terminal of device of a user for administrating data including privacy of said user, comprising:
(a) a first unit which acquires a privacy policy from said server;
(b) a memory storing a privacy preference established by said user; and
(c) a controller which determines whether it is allowed to provide said data including privacy of said user to said server, based on comparison of said privacy preference and said privacy policy to each other.

17. The privacy data administrator as set forth in claim 16 further comprising a second unit which, when said controller determines that it is allowed to provide said data including privacy of said user, transmitted from said terminal device, to said server, transmits said data including privacy of said user to said server from said terminal device therethrough.

18. The privacy data administrator as set forth in claim 16, further comprising a third unit which receives from said server a request to provide said data including privacy of said user to said server,
said third unit, when said controller determines that it is allowed to provide said data including privacy of said user to said server, receives said data from said terminal device, and transmits said data to said server.

19. The privacy data administrator as set forth in claim 16, wherein said controller, when said controller determines that it is not allowed to provide said data including privacy of said user to said server, outputs data indicative of inconsistency between said privacy preference and said privacy policy.

20. The privacy data administrator as set forth in claim 16, further comprising a fourth unit which, when said controller determines that it is not allowed to provide said data including privacy of said user to said server, transmits a first inquiry to said terminal device as to whether it is allowed to provide said data including privacy of said user to said server, and receives a reply from said terminal device.

21. The privacy data administrator as set forth in claim 20, wherein said fourth unit displays said first inquiry and a reply form to make an answer to said first inquiry, in a display unit of said terminal device.

22. The privacy data administrator as set forth in claim 20, wherein said fourth unit transmits said first inquiry together with data indicative of inconsistency between said privacy preference and said privacy policy, to said terminal device.

23. The privacy data administrator as set forth in claim 20, further comprising a second memory to store said reply,
and wherein said fourth unit, when said controller has determined that it was not allowed to provide said data including privacy of said user to said server, (a) checks whether a reply having been made in response to an inquiry identical with said first inquiry is stored in said second memory, (b) if said reply is stored in said second memory, does not transmit said inquiry identical with said first inquiry to said terminal device, and (d) treats said reply stored in said second memory as a reply to be made in response to said inquiry.

24. The privacy data administrator as set forth in claim 23, wherein said second memory stores not only said reply, but also at least one of a duration in which said reply should be stored, data which identifies a user of said terminal device from which said reply was transmitted, and data which identifies said server.

25. The privacy data administrator as set forth in claim 20, wherein said fourth unit updates said privacy preference of said user, based on said reply having been made in response to said inquiry.

26. The privacy data administrator as set forth in claim 16, further comprising:
a third memory storing therein data indicative of results of comparison of said privacy preference and said privacy policy to each other; and
a privacy data filter which revises said data including privacy of said user, in accordance with said privacy preference, based on said data stored in said third memory.

27. The privacy data administrator as set forth in claim 16, further comprising:
a third memory storing therein both data indicative of results of comparison of said privacy preference and said privacy policy to each other, and said reply having been made in response to said inquiry; and
a privacy data filter which revises said data including privacy of said user, in accordance with said privacy preference, based on said data stored in said third memory.

28. The privacy data administrator as set forth in claim 26, wherein said third memory stores data indicative of a kind of said data including privacy of said user, extracted from said privacy policy.

29. The privacy data administrator as set forth in claim 26, wherein said third memory stores not only said stores data indicative of a kind of said data including privacy of said user, extracted from said privacy policy, but also at least one of a duration in which said data should be stored, data which identifies a user who has said privacy preference, and data which identifies said server having said privacy policy.

30. The privacy data administrator as set forth in claim 16, wherein said controller administrates said data including privacy of said user in accordance with P3P (Platform for Privacy Preference).

31. The privacy data administrator as set forth in claim 16, wherein said privacy data administrator acts as a gateway through which said server and said terminal device are connected to each other.

32. A program for causing a computer to act as a privacy data administrator for administrating data including privacy of said user in communication made between a server and a terminal of device of a user, said privacy data administrator comprising:
(a) a first unit which acquires a privacy policy from said server;
(b) a memory storing a privacy preference established by said user; and
(c) a controller which determines whether it is allowed to provide said data including privacy of said user to said server, based on comparison of said privacy preference and said privacy policy to each other.

33. The program as set forth in claim 32, wherein said privacy data administrator further includes a second unit which, when said controller determines that it is allowed to provide said data including privacy of said user, transmitted from said terminal device, to said server, transmits said data including privacy of said user to said server from said terminal device there through.

34. The program as set forth in claim 32, wherein said privacy data administrator further includes a third unit which receives from said server a request to provide said data including privacy of said user to said server,
said third unit, when said controller determines that it is allowed to provide said data including privacy of said user to said server, receives said data from said terminal device, and transmits said data to said server.

35. The program as set forth in claim 32, wherein said controller, when said controller determines that it is not allowed to provide said data including privacy of said user to said server, outputs data indicative of inconsistency between said privacy preference and said privacy policy.

36. The program as set forth in claim 32, wherein said privacy data administrator further includes a fourth unit which, when said controller determines that it is not allowed to provide said data including privacy of said user to said server, transmits a first inquiry to said terminal device as to whether it is allowed to provide said data including privacy of said user to said server, and receives a reply from said terminal device.

37. The program as set forth in claim 36, wherein said fourth unit displays said first inquiry and a reply form to make an answer to said first inquiry, in a display unit of said terminal device.

38. The program as set forth in claim 36, wherein said fourth unit transmits said first inquiry together with data indicative of inconsistency between said privacy preference and said privacy policy, to said terminal device.

39. The program as set forth in claim 36, wherein said privacy data administrator further includes a second memory to store said reply,
and wherein said fourth unit, when said controller has determined that it was not allowed to provide said data including privacy of said user to said server, (a) checks whether a reply having been made in response to an inquiry identical with said first inquiry is stored in said second memory, (b) if said reply is stored in said second memory, does not transmit said inquiry identical with said first inquiry to said terminal device, and (d) treats said reply stored in said second memory as a reply to be made in response to said inquiry.

40. The program as set forth in claim 39, wherein said second memory stores not only said reply, but also at least one of a duration in which said reply should be stored, data which identifies a user of said terminal device from which said reply was transmitted, and data which identifies said server.

41. The program as set forth in claim 36, wherein said fourth unit updates said privacy preference of said user, based on said reply having been made in response to said inquiry.

42. The program as set forth in claim 32, wherein said privacy data administrator further includes:
a third memory storing therein data indicative of results of comparison of said privacy preference and said privacy policy to each other; and
a privacy data filter which revises said data including privacy of said user, in accordance with said privacy preference, based on said data stored in said third memory.

43. The program as set forth in claim 32, wherein said privacy data administrator further includes:
a third memory storing therein both data indicative of results of comparison of said privacy preference and said privacy policy to each other, and said reply having been made in response to said inquiry; and
a privacy data filter which revises said data including privacy of said user, in accordance with said privacy preference, based on said data stored in said third memory.

44. The program as set forth in claim 42, wherein said third memory stores data indicative of a kind of said data including privacy of said user, extracted from said privacy policy.

45. The program as set forth in claim 42, wherein said third memory stores not only said stores data indicative of a kind of said data including privacy of said user, extracted from said privacy policy, but also at least one of a duration in which said data should be stored, data which identifies a user who has said privacy preference, and data which identifies said server having said privacy policy.

46. The program as set forth in claim 32, wherein said controller administrates said data including privacy of said user in accordance with P3P (Platform for Privacy Preference).

47. The program as set forth in claim 32, wherein said privacy data administrator acts as a gateway through which said server and said terminal device are connected to each other.

48. A method of administrating data including privacy of a user in communication made between a server and a terminal device of said user in a system including a server, a user's terminal device and a privacy data administrator connected between said server and said terminal device, comprising the steps of:
(a) comparing a privacy policy made by said server and a privacy preference determined by said user to each other, said step (a) being to be carried out by said privacy data administrator; and
(b) determining whether it is allowed to provide data including privacy of said user to said server.

49. The method as set forth in claim 48, further comprising the steps of, when it is determined that it is not allowed to provide said data including privacy of said user to said server, transmitting a first inquiry to said terminal device as to whether it is allowed to provide said data including privacy of said user to said server, and receiving a reply from said terminal device.

50. The method as set forth in claim 49, further comprising the steps of:
storing said reply made in response to each of various inquiries;
when it was determined that it was not allowed to provide said data including privacy of said user to said server, checking whether a reply having been made in response to an inquiry identical with said first inquiry is stored;
if said reply is stored therein, not transmitting said inquiry identical with said first inquiry to said terminal device; and
treating said reply stored therein as a reply to be made in response to said inquiry.

51. The method as set forth in claim 49, further comprising the step of revising said data including privacy of said user in accordance with said privacy preference, based on comparison of said privacy preference to said privacy policy.

52. The method as set forth in claim 49, further comprising the step of revising said data including privacy of said user in accordance with said privacy preference, based on both comparison of said privacy preference to said privacy policy and said reply having been made from said terminal device in response to said inquiry.
